(19) United States
(12) Patent Application Publication
(10) Pub. No.: US 2004/0117307 A1
(43) Pub. Date: Jun. 17, 2004

(54) Method and system for a self storage facility to manage user accounts at a remote location

(76) Inventors: Anthony Carlis, Downingtown, PA (US); James Del Sordo JR., East Brandywine, PA (US)

Correspondence Address: Invent This! Inc., The Law Office of Anthony R. Carlis, 34 Kristin Circle, Downingtown, PA, 19335-1030, US

(21) Appl. No.: 10/702,570

(22) Filed: Nov. 5, 2003

Related U.S. Application Data
(60) Provisional application No. 60/423,796, filed on Nov. 5, 2002.

(51) Int. Cl. G06F 17/60

(52) U.S. Cl. 705/41

(57) ABSTRACT

The present invention is for a system and a method allowing a client to set-up and/or make payments at a remote station including a home PC via the Internet for a self-storage facility. The storage facility comprises a plethora of units for the purpose of safekeeping client's article. More particularly, the present invention relates to an automated storage system comprising electronically linked units which are attached to a computer with a database. A client will be able to make unattended transactions. If a customer/client is delinquent, it is the intent of the present invention to allow the customer/client to become current without the need for or with the minimum of human involvement. The present invention also allows a potential customer to become a current customer by allowing the potential customer to set up a contract for rental completely electronically, if the laws of the governing sovereignty allow.

### CROSS REFERENCE TO RELATED APPLICATION(S)

This application claims priority from U.S. provisional application no. 60/423,796 which was filed on Nov. 5, 2002, which is incorporated by reference as if fully set forth.

### FIELD OF INVENTION

The present invention is for a system and a method allowing a client to set-up and/or make payments at a remote station. The present invention relates generally to self-storage facilities, also commonly referred to as a “mini-storage” facilities. A client/customer rents space in the mini-storage facility and a single space is commonly known as a unit. The storage facility comprises a plethora of units for the purpose of safekeeping client's article. More particularly, the present invention relates to an automated storage system comprising electronically linked units which are attached to a computer with a database. As the need arises, a client will be able to make unattended transactions twenty-four hours a day, seven days a week. If a customer/client is delinquent, it is the intent of the present invention to allow the customer/client to become current without the need for or with the minimum of human involvement. The present invention also allows a potential customer to become a current customer by allowing the potential customer to set up a contract for rental completely electronically, if the laws of the governing sovereignty allow. If the laws do not allow for such electronic commerce, the present invention will expedite the contract process by gathering much of the required information ahead of time.

### BACKGROUND OF THE INVENTION

Self-storage facilities are well known in the art and generally comprise a plurality of individual storage units enclosed by a secured perimeter for the purpose of safeguarding/storing articles. A typical arrangement has each storage unit within a garage or shed-like structure for receiving the client's goods/articles. The unit has a door member for accessing the interior of the storage unit, and a locking mechanism for securing the door member in a locked position. The secured perimeter typically includes a fence or barrier surrounding the storage facility having at least one gate for ingress and egress, wherein the gate access is restricted to only those individuals having proper clearance or authorization to enter the storage. For example, an electronic gate controller is programmed to allow access by individual or storage unit.

Storage units are usually rented for various periods of time to accommodate the needs of the client. First, the renting of the individual storage units is typically accomplished by manning each storage facility with at least one attendant on duty who can transact with potential customers and assign available storage units. The problem with this is the need to have an attendant at each storage facility to conduct any and all transactions. This increases the overhead costs associated with operating the self storage facility. More specifically, the office building or attendant station is costly in terms of the materials used for construction, as well as the costs of heating, air conditioning, and/or equipping the office space with the tools for conducting business.

A need therefore exists for an improved self storage system which overcomes the aforementioned deficiencies in the prior art. To be more specific, a need exists for an improved self storage system which obviates the need for an attendant to be on duty for the purpose of transacting with potential customers and handling all other associated transactions with current transactions.

A further need exists for an improved self storage system which allows potential and current customers to conduct business with self storage facilities from a variety of different geographical locations. For example, at the entry gate of the storage facility or from home on a personal computer via the Internet.

Additionally, the proliferation of self storage facilities forces owners to compete and are forced to operate on a thin profit margin. One of the highest costs incurred to the owner is the salaries of the people who staff the office of each facility to interact with the customer. When a new client wishes to rent a storage unit, a person must be present to facilitate the transaction. This person is usually an employee of the facility or its managing company and must be at the facility to complete the paperwork. If the owner cannot arrange for someone to meet the prospective customer within a reasonable period of time at the storage facility's location, the client may chose not to rent from this facility, thus the owner will loose business.

Another problem associated with a twenty-four, seven days a week self-storage environment occurs when a customer becomes delinquent in her account with the self-storage facility. The client may not be aware of her delinquency and will be banned from accessing the storage facility. Not only is the client unhappy, the storage-facility owner or manager must somehow meet the client and resolve the delinquency. Resolution may involve a significant time period, all the while, the client is barred from accessing her storage unit.

### SUMMARY

The present invention is a system and a method which allows a new client to set-up an account with a self-storage facility over the internet, at the gate of the self-storage facility or by an automated telephone system. This allows the owner to employ less people, thus saving costs. The present invention also permits twenty-four hour, seven day a week access required by clients. The present invention will also allow a delinquent client to become current and with allow the client to client check her account status at the gate, on-line or over the telephone.

### BRIEF DESCRIPTION OF THE DRAWING(S)

FIG. 1 shows a terminal box which allows the client to access her account, make payments and open the gate.

### DETAILED DESCRIPTION OF THE PREFERRED EMBODIMENT(S)

The present invention will be described with reference to the drawing figures wherein like numerals represent like elements throughout.

It is the object of the present invention to allow the unattended operation of a self storage facility. This allows the owner to supply fewer workers at a self-storage facility, thus saving costs.

It is a further object of the present invention to allow clients to conduct a plethora of transactions outside of the presence of a human office worker. A client will be able to approach a storage faculty and through remote terminal, the potential client will be able to determine the availability of any storage units and their associated sizes.

The potential client will then be able to process their request for rental and print out a contract. The process includes obtaining a payment from the potential client and collecting other required information. If the laws of the local sovereign allow, the potential client will be permitted to complete the transaction and obtain a storage unit at that moment in time. The potential client will then become a client.

If the local sovereign's laws do not permit electronic self storage initial client rental, the potential client's information is saved and/or printed out. The potential client will then be able to return to the storage facility and a convenient time to complete the required processing. This allows the transaction to be completed much more quickly at this convenient time, due to the fact that much of the information gathering is already accomplished.

In yet another object of the present invention, it allows clients who rent are in the arrears, an opportunity to become current, even when the storage facility's office is unattended or closed. The client becomes aware of the arrearages when their access is barred at an electronic gate. The client can then make some sort of payment at a remote terminal.

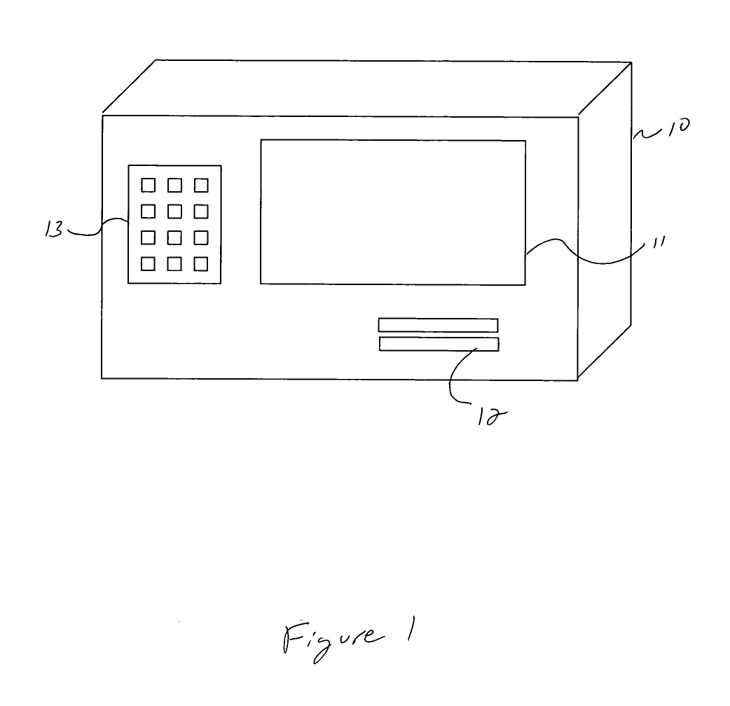

FIG. 1 illustrates a remote terminal 10 comprising a LCD or CRT display 11, a credit card swipe 12 and a keypad 13. This device could be a Kiosk type device placed inside the storage facility's office, a terminal hung on the outside wall of the office or it can be incorporated into the electronic gate access system and actually placed at one or more of the facility's gates.

As a Kiosk located inside the office, the remote terminal 10 frees up the office staff to perform associated functions necessary for self storage management. For example, the office person is free to show a potential customer the facility while and existing customer rents an additional unit or makes their account current. The inside kiosk also permits potential customers to become customers by allowing them to rent a unit while the office person is busy assisting other customers.

If the remote terminal 10 is attached to the wall out side the office, it will permit twenty-four hour access to potential and current clients. A potential client will be able to provide any and all necessary information for unit rental. Delinquent clients after discovering that they are not permitted into their storage unit, will be able to become current.

If the remote terminal 10 is located at with or incorporated into the electronic gate access device, a delinquent client once informed of their delinquency will be able to pay at the gate and become current. In addition, the owner of the storage facility will be able to inform clients of any special offers the self storage facility is offering by displaying sale information. For example, the self storage facility will be able to display special offers, such as discounts for prepaying rent or offers to the client for the opportunity to purchase storage boxes at a special price. The special offers can also be implemented into all aforementioned remote terminal 10 locations, whether inside, on the wall or at the gate.

Storage facilities can control ingress and egress via electronic remote gates. When a client drives their car up to the gate, they will usually enter a aces s code or swipe a card in a card reader to obtain access. The present invention is not limited to these two access methods, it should be noted the car may have an radio frequency id tag, a bar code affixed to it or any number of ways to let the access control software that the person at the gate is valid client/customer.

For the exemplary purposes, the present discussion will be limited to a client entering an access code via keypad at the gate of the facility. The client identifies them self and some software program must determine if the validity of the patron. In one system, the gate control keypad has intelligence and a software database is downloaded into the gate controller with valid current users. This type of device is known as a smart controller. When a user enters a valid code, the keypad sends a signal to open the gate.

In another gate control access system, the gate control keypad has no intelligence and is connected to a gate controller via cabling. The keypad merely passes on the keys that were entered to the gate controller. The gate controller determines if the code was valid and opens the gate. The gate controller can be a microcontroller based system or a personal computer (PC). The advantage to a PC is that the software to operate the gate controls and the storage facility's accounting software can be on the same machine.

When the storage facility uses intelligent keypads and a client is barred access due to a delinquency, the intelligent keypad must inform the client of problem with their account. The client then is asked to use an adjacent remote terminal 10 to bring the client up to date. The remote terminal 10 prompts the user for an id and unit number. The remote terminal 10 contacts the accounting system software and requests a balance due for the particular client. The balance is reported back to the client along with a choice of paying the balance via a debit or credit card on file, paying with a debit or credit card at the remote terminal 10 or doing nothing and allowing the client to resolve the delinquency at a later time.

For example, the client chooses to pay by credit card at the remote terminal 10. A card is swiped and the information is sent to an accounting software program which gets credit card authorization from an authorization agency and charges the credit card. If authorization fails, the accounting software reports back to the remote terminal 10 to prompt the user to try the same card again, try a different card or abort the operation.

If the authorization is a success, the accounting software program reports the success to the user. A receipt may be then printed if the remote terminal 10 has a printer attached. The accounting software also updates the client database which is downloaded to the intelligent keypad allowing the client to then obtain access. In addition to the software download to the intelligent keypad, the accounting software may instruct the remote terminal 10 to then open the gate if the remote terminal 10 is within close proximity of the intelligent keypad. This feature would not be practical if the remote terminal 10 were on the building or inside an office. The gate software would probably time out before a client could get back in his car and drive through the gate. It would however be practical in an inside storage facility which has a walk up clientele. If the remote terminal 10 is integrated into the access system, the above authorization procedure would still have to be executed.

When a non-intelligent key pad is connected to gate controller, the remote terminal 10 device should be utilized to prompt the user for payment options and update the account database. The accounting software would then have to download to the gate controller microcontroller that the client is now current and access should be allowed. If there is a possibility of a large lead time between notification of a successful credit card transaction to the user and updating the microcontroller, the remote terminal 10 should be instructed to open the gate for the now paid up client.

When the remote terminal 10 is the gate entry device, a series of special offers can be displayed on the screen tempting the clients to purchase additional things. For example, the client would be prompted to pay the rent early and get a discount. The discount could be a percentage off the rent price or free additional time. Another example would be to offer the client boxes or other special storage needs.

In yet another embodiment, the present system could be accessed via the Internet. This would allow potential clients and current clients to setup rental arrangements at the self storage facility. The same Internet pathway could be used to allow customers to view their accounts and make payments.

What is claimed is:

1. A remote terminal to be installed at a self storage facility to aide the owner by processing transactions, comprising:
a display device to interact with a plurality of clients;
a keypad to allows said plurality of clients to enter a plurality of prompted responses;
at least one connection to a software database to determine said client's balance;
an access to a clearing agency to obtain an authorization on said payment card; and
a first software program to coordinate the transaction between the remote terminal, the clearing agency and the software database.

2. The remote terminal in claims 1 or 2, further comprising a magnetic card reader to allow a client to swipe a payment card.

3. The remote terminal in claim 2, further comprising a printer to obtain a print out of at least one of a plurality of transactions.

4. The remote terminal of claims 1 or 2, further comprising a second software program to allow said remote terminal to set up a rental in a self storage environment.

5. The remote terminal in claims 1 or 2, further comprising a third software program to allow said plurality of clients to make their accounts current and allow access to self storage facility.

6. The remote terminal in claims 1 or 2, further comprising a relay device which upon a successful transaction will operate and open a security gate allowing a client access.

7. The remote terminal in claims 1 or 2, further comprising a plurality of special offers to be displayed on said display to entice said client to purchase a plurality of additional storage equipment.

8. The remote terminal in claim 1, further comprising an access to the Internet to allow said client to view and update their account.

9. The method of obtaining access to a self storage facility wherein a client is delinquent in rent; consisting
notifying the client that their account is delinquent;
prompting said client to report a balance due;
obtaining said balance due from at least one of plurality of databases;
prompting said client to make a payment;
obtaining said client payment information;
authorizing payment from a payment authorization entity;
notifying said client of a successful transaction;
updating said client information in at least one of a plurality of databases; and
allowing said client access upon successful completion of said successful transaction.

10. The method of claim 9, wherein said client payment information is kept in at least one of said plurality of databases.

11. The method of claim 9, wherein said client payment information is swiped and read off a payment card.

12. The method of setting up an account at a self storage facility; consisting of notifying a potential client what units are available from a list of units in a unit database;
prompting said potential client to make a payment;
obtaining said client payment information;
authorizing payment from a payment authorization entity;
notifying said potential client of a successful transaction;
updating said potential client information in at least one of a plurality of databases; and
allowing said potential client access upon successful completion of said successful transaction.

13. The method of claim 12, wherein a plurality of transactions are conducted over the Internet, further consisting:
prompting said potential client to pick a storage unit from a plurality of available storage units;
collecting information from said potential customer including payment card information;
verifying payment card information;
approving said potential client; and
assigning said potential client to the selected storage unit.
